(19) United States
(12) Patent Application Publication
(10) Pub. No.: US 2007/0041037 A1
(43) Pub. Date: Feb. 22, 2007

(54) Systems and methods for confirmed document transmission

(75) Inventors: Gene Golovchinsky, Menlo Park, CA (US); Jonathan Trevor, Santa Clara, CA (US)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD.

(21) Appl. No.: 11/206,434

(22) Filed: Aug. 17, 2005

(51) Int. Cl. G06F 3/12

(52) U.S. Cl. 358/1.15

(57) ABSTRACT

Techniques are provided for determining a document, an authenticated document sender and an intended document recipient. The intended recipient of the document is optionally notified of new documents available for review. A non-optional delivery confirmation is recorded when an authenticated recipient reads, prints, forwards or otherwise accesses the document. The sender is optionally notified when the non-optional delivery confirmation is recorded.

### BACKGROUND OF THE INVENTION

1. Field of Invention

This invention relates to the confirmed transmission of documents.

2. Description of Related Art

Conventional facsimile and email document transmission systems transmit documents between connected telecommunications circuits. For example, some conventional facsimile systems use circuit switched telephone connections to transmit sensitive and/or proprietary information between a set of sending and receiving devices. However, these conventional systems are device oriented. That is, the document is transmitted from a sending device to a specific receiving device. In some cases, the sending device also receives notification that a transmission was successful. However, no confirmation is provided that the document has been received by the intended recipient of the document. Moreover, these conventional systems typically delete the transmitted document once the receiving device indicates successful receipt. For mobile recipients, it may be necessary for the sender to route the document to a receiving device that is both, accessible by the mobile recipient and proximate to the current or future location of the mobile recipient. This may take several attempts and may require several scans of the original document. If the destination device is inaccessible or the recipient is no longer proximate to the receiving device, the recipient will not receive the transmitted document. In cases where the document is transmitted too early or too late, the security of the document may be compromised by other users of the receiving device. Thus, systems and methods for a confirmed document transmission system would be useful.

### SUMMARY OF THE INVENTION

The systems and methods according to this invention provide for determining a document, an authenticated document sender and an intended document recipient. The intended recipient of the document is optionally notified of new documents available for review. A non-optional delivery confirmation is recorded when an authenticated recipient reads, prints, forwards or otherwise accesses the document. The sender is optionally notified when the non-optional delivery confirmation is recorded.

### BRIEF DESCRIPTION OF THE DRAWINGS

FIG. 1 is a first overview of an exemplary confirmed document transmission system according to this invention;

FIG. 2 is an exemplary flowchart of a method for sending confirmed documents according to this invention;

FIG. 3 is an exemplary flowchart of a method for confirmed document receipt according to this invention;

FIG. 4 shows an exemplary confirmed document transmission system according to this invention;

FIG. 5 is a second exemplary overview of a confirmed document transmission system according to this invention;

FIG. 6 is a third exemplary overview of a confirmed document transmission system according to this invention;

FIG. 7 is an exemplary overview of two confirmed document transmission systems according to this invention;

FIG. 8 is a fourth exemplary overview of a confirmed document transmission system according to this invention; and

FIG. 9 is an exemplary data structure for storing delivery confirmation information according to this invention.

### DETAILED DESCRIPTION OF EXEMPLARY EMBODIMENTS

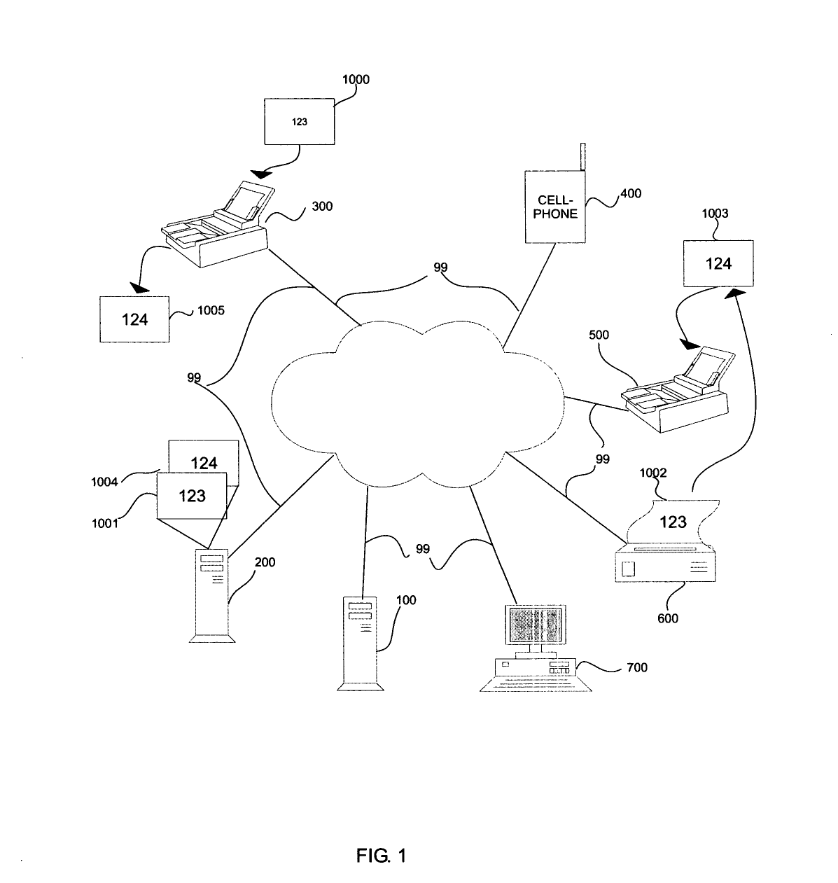

FIG. 1 is an overview of a first exemplary confirmed document transmission system 100 according to this invention. The confirmed document transmission system 100 is connected via a communications link 99 to a first multi-function device 300, a cell-phone 400, a second multi-function device 500, a facsimile device 600, a personal computer 700 and a document repository 200. Document repositories include, but are not limited to, file transfer protocol (FTP) servers, web servers, database systems and/or any known or later developed system for storing and/or organizing documents.

In one exemplary embodiment, the user of the first multi-function device 300 creates en electronic document by scanning in a paper based contract document 1000 using the scanning functionality of the first multi-function device 300. A first user is authenticated to the system for confirmed document transmission 100 using a user id and password and/or any known or later developed authentication technique or method.

The first user selects a second user as the intended recipient of the document. The electronic document is transferred from the first multi-function device 300 via the system for confirmed document transmission 100 to an information repository 200. In various exemplary embodiments according to this invention, the document is stored within an information repository 200 or document store embedded within the system for confirmed document transmission 100. However, it will be apparent that the information repository 200 or document store may be located at any point accessible via communications links 99 without departing from the scope of this invention.

The system for confirmed document transmission 100 optionally notifies the second user or intended recipient, that an electronic document is available for review. In various exemplary embodiments according to this invention, the users are notified of available documents by a short message service (SMS) or text message to the cellphone 400, via email, voice mail and/or using any known or later developed communication method.

The second user or intended recipient is authenticated to the system for confirmed document transmission 100 using cellphone 400 and/or any other input device. The cellpone and/or any other input device is used to select the document. The selected document is then routed to a nearby facsimile device 600 such as the facsimile device in an airport lounge, mobile office or the like. The second user or intended recipient reads, prints, faxes or otherwise accesses the document. The system for confirmed document transmission 100 then records a non-optional delivery confirmation indicating that the document has been delivered and accessed by the second user or intended recipient.

In various other exemplary embodiments according to this invention, an optional notification message based on short message service, chat or instant messages, electronic mail, voice mail and/or any known or later developed notification or messaging method, notifies the second user or intended recipient of the documents available for access.

The second user or intended recipient then reviews and executes the printed contract document. When the second user or intended recipient checks into their hotel, a second multi-function device 500 is used to scan in the signed printed contract to create a second electronic document. The second user is then authenticated. The second user then becomes the sender of the second document. The second user forwards the second electronic document via the system for confirmed document transmission 100 to the first user who is now the new intended recipient. The first user is optionally notified of the newly available document for review using short message service (SMS), electronic mail, voicemail, facsimile to the first multi-function device 300 or the like. The first user is authenticated to the system for confirmed document transmission 100. In various exemplary embodiments, the first user implicitly or explicitly routes the second document for printing on the first multi-function device 300. The system for confirmed document transmission 100 records the non-optional delivery confirmation. In various exemplary embodiments, the non-optional delivery confirmation is forwarded to the second user to notify the second user that the second document has been accessed by the first user.

In various other embodiments according to this invention, the electronic document is accessed from a data source by the confirmed document transmission system 100. The data source may be a file system, a document repository or the like. In various exemplary embodiments multiple data sources may be used without departing from the scope of this invention.

The sending user is authenticated and a receiving user determined. An authenticated receiving user optionally routes the document to a proximate output device. The output device may include, but is not limited to an electronic document viewing manager or routine running on the personal computer 70, a multifunction device or the like. When the authenticated receiving user accesses the document, a non-optional delivery confirmation is recorded. The availability of the received document is optionally reported to the receiving user. An optional report may also be generated which notifies the sending user of recorded non-optional delivery confirmations.

A report may include or be based on, a message, a signal, a facsimile and/or any known or later developed communication. For example, in some exemplary embodiments according to this invention, the report is an electronic mail message sent to the sending user's personal digital assistant. However, short message service (SMS), voicemail, text or chat messages or the like may also be used without departing from the scope of this invention.

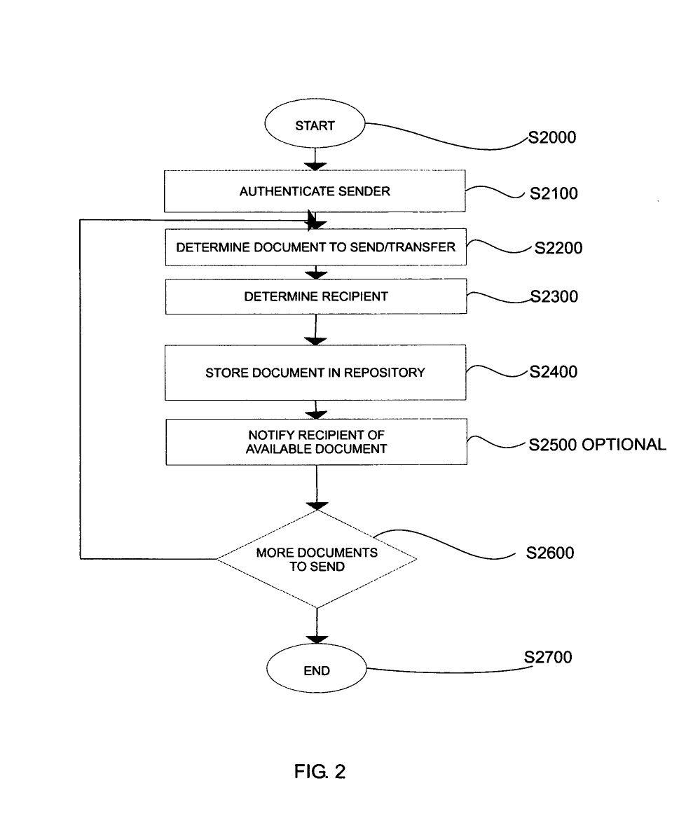

FIG. 2 is an exemplary flowchart of a method for sending confirmed documents according to this invention. The process begins at step S2000 and immediately continues to step S2100.

In step S2100, the sender of the document is authenticated. In various exemplary embodiments according to this invention, the sender is authenticated based on a user identifier and password, and/or any other known or later developed authentication method. After the sender is authenticated, control continues to step S2200.

The document to be transferred to the sender is determined in step S2200. The document is selected using a drop down dialog box, a mouse or pen gesture, entered directly and/or entered using any known or later developed input method. After the document has been determined, control continues to step S2300.

In step S2300, the intended recipient of the document is determined. In various exemplary embodiments according to this invention, the recipient information is extracted from the address field of the document, entered directly, selected from a list of addresses and/or determined using any known or later developed method for determining recipients. After the recipient has been determined, control continues to step S2400.

The document is stored in an information repository in step S2400. The information repository may be a corporate or organizational repository stored in a web server, an ftp server, a database and/or any known or later developed information repository useful in providing access for a document recipient. After the document has been stored, control continues to optional step S2500.

In optional step S2500, the intended recipient of the document is notified that a document is available for review. The recipient notification may be based on, but is not limited to, a database update, a short message, voice mail, electronic mail and the like.

In step S2600, a determination is made as to whether there are additional documents to be sent. If there are additional documents to be sent, control immediately jumps to step S2200. Steps S2200-S2600 are then repeated until it is determined in step S2600 that there are no additional documents to be sent. When it has been determined in step S2600 that no additional documents remain to be sent, control continues to step S2700 and the process ends.

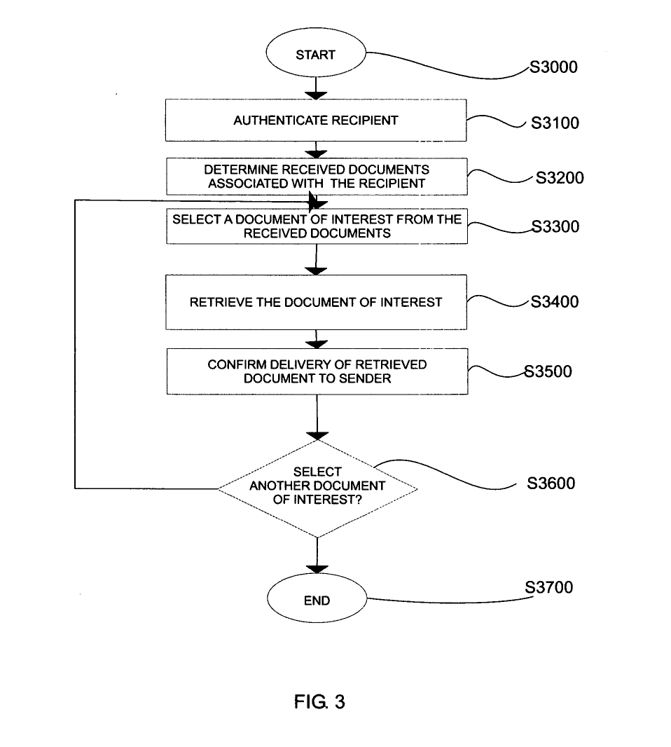

FIG. 3 is an exemplary flowchart of a method for confirmed document receipt according to this invention. The process begins at step S3000 and immediately continues to step S3100.

The recipient of the document is authenticated in step S3100. In various embodiments according to this invention, the recipient is authenticated based on a user identifier and a password, and/or using any other known or later developed authentication method. After the document recipient has been authenticated, control continues to step S3200 where the documents associated with the recipient are determined. After determining the documents, control continues to step S3300.

In step S3300, a document of interest is selected from the set of documents received by the recipient. As discussed above, documents are selected using drop-down dialog boxes, entering a filename into a text field or the like. After the document of interest has been selected, control continues to step S3400.

The selected document of interest is then retrieved in step S3400. The documents may be retrieved using the file transport protocol (FTP), hyper text transfer protocol (HTTP) or any known or later developed protocol or communications method without departing from the spirit or scope of this invention. After the document of interest has been retrieved, control continues to step S3500.

In step S3500, the delivery of the retrieved document is confirmed. The non-optional confirmation may include, but is not limited to, a database update which records the time the intended recipient accesses the document. In various other exemplary embodiments according to this invention, the sending user is optionally notified that a delivery confirmation has been recorded, via an electronic mail message, a facsimile message and/or any message or signal forwarded to the sender. After the delivery of the retrieved document has been confirmed, control continues to step S3600.

A determination is made as to whether there are additional documents of interest to be selected and confirmed in step S3600. If there are additional documents to be confirmed, control immediately jumps to step S3300. Step S3300-S3600 are then repeated until it is determined that there are no additional documents to be selected or confirmed. When no additional documents remain to be confirmed, control continues to step S3700 and the process ends.

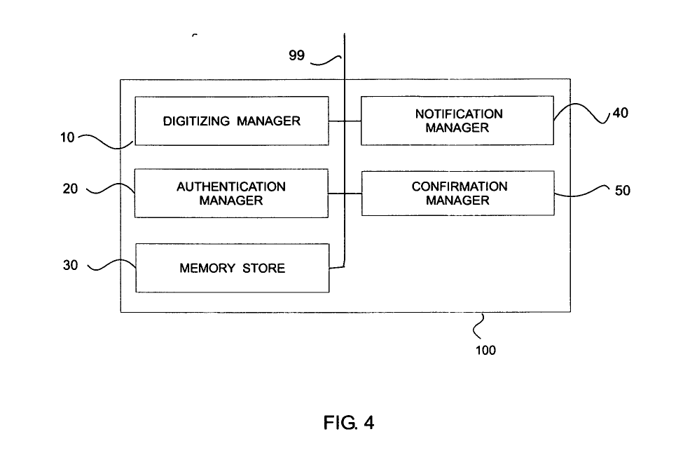

FIG. 4 shows an exemplary confirmed document transmission system 100 according to this invention. The authentication manager 20 is activated to authenticate a sending user to the confirmed document transmission system 100. For example, in one exemplary embodiment, the authentication manager 20 initiates a login session. The login session authenticates the sending user based on the entry of a user identifier and password combination. However, it will be apparent that any known or later developed user authentication method may also be used without departing from the scope of this invention.

A document specified by the sending user is digitized by activating the digitizing manager 10 to create an electronic document. The digitizing manager 10 may include, but is not limited to a multi-function device, a scanner, a document camera, a charge coupled device (CCD), a video digitizer, an audio digitizer and/or any known or later developed device useful in creating an electronic document based on the document.

The electronic document is then stored in the memory store 30. It will be apparent that in various embodiments according to this invention, the memory store 30 may be an internal memory, a document repository and/or any other information repository accessible via communications links 99. The optional notification manager 40 is activated to notify the intended receiving user that a document is available for review. Optionally, the system can be queried to inform the intended receiving user that a document is available for review. However, in still other embodiments according to this invention, the optional notification manager 40 may be used to forward a message to the intended receiving user via short message service (SMS), a chat or instant message, voice mail, a facsimile message, electronic mail and/or any other known or later developed means of communication.

The authentication manager 20 is then activated to authenticate the intended receiving user. Once the authenticated receiving user accesses the electronic document, the confirmation manager 50 is activated to record a non-optional delivery confirmation. For example, when an authenticated receiving user reads, reviews, prints or otherwise accesses the electronic document, a non-optional delivery confirmation is generated. For example, the non-optional delivery confirmation may be a database update that records the time when the receiving user accesses the electronic document. In various other exemplary embodiments according to this invention, a short message (SMS), chat or instance message, an electronic mail message, voice mail message or other indicator or message is then forwarded to notify the sending user that the non-optional delivery confirmation has been recorded.

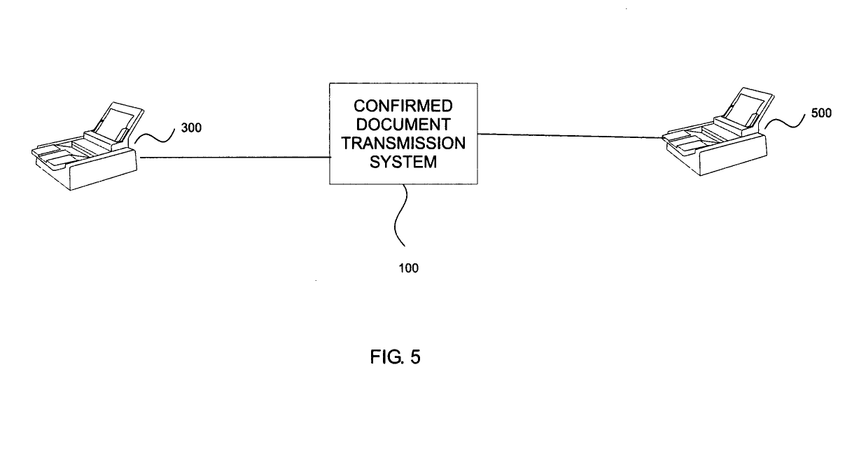

FIG. 5 is a second exemplary overview of a confirmed document transmission system 100 according to this invention. The confirmed document transmission system utilizes a first multi-function device 300 as a digitizing circuit or manager. A sending user is authenticated to the system for confirmed document transmission 100 using a card swipe, biometric authentication, login sequence and/or other means of authentication on the first multi-function device 300. An electronic copy of a physical document to be transmitted to a receiving user is generated by the first multi-function device 300 and forwarded to the confirmed document transmission system 100. The confirmed document transmission system 100 stores the electronic document and optionally notifies the receiving user of the newly available document. The receiving user is authenticated via a login sequence and/or any other known or later developed method of authenticating the user.

For example, in one exemplary embodiment, the receiving user is authenticated via a login sequence at the second multifunction device 500. Once the receiving user accesses the document by reading, forwarding, faxing or the like, a non-optional delivery confirmation is recorded. The non-optional delivery confirmation may include, but is not limited to, a record in a database specifying the time the receiving user accessed the electronic document. In various other embodiments, an optional notification message, signal or indicator is forwarded to the sending user based on the non-optional delivery confirmation. The notification message, signal, indicator is based on a short message service message (SMS) text message, an electronic mail message, a voice mail message, chat or instant messages and/or any known or later developed communication method.

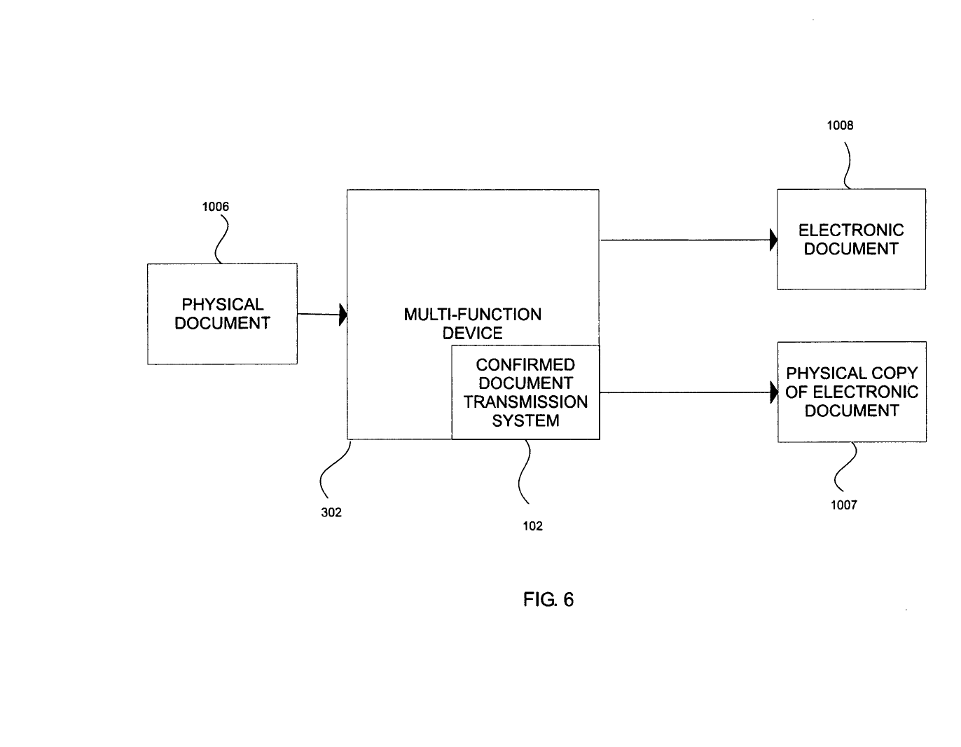

FIG. 6 is a third exemplary overview of a confirmed document transmission systems 102 according to this invention. A third multifunction device 302 contains an embedded confirmed document transmission system 102.

The sending user is authenticated to the exemplary embedded confirmed document transmission system 102 using a login identifier and password or other means of authentication. The sending user scans the physical document 1006 using the scanning functionality of the third multi-function device 302 to create an electronic copy of the document. A receiving user is entered by the sender and/or extracted from the document. The embedded confirmed document transmission system 102 stores the electronic document.

The receiving user is optionally notified that a new document is available for review. The receiving user is authenticated to the embedded confirmed document transmission system 102 using a login and password or other means. In one exemplary embodiment, the user enters a login or user identifier and password on the input interface of the third multi-function device 302. When the receiving user prints, forwards, reads or otherwise accesses the electronic document, a non-optional delivery confirmation is recorded by the embedded confirmed document transmission system 102.

In some exemplary embodiments, an optional sending user notification is forwarded to the sending user to indicate that the receiving user has accessed the received document. The receiving user may directly access the electronic document 1008 using an electronic document viewer or the like. Alternately, a physical copy of the electronic document is printed by the multi-function device 302 and/or other output device.

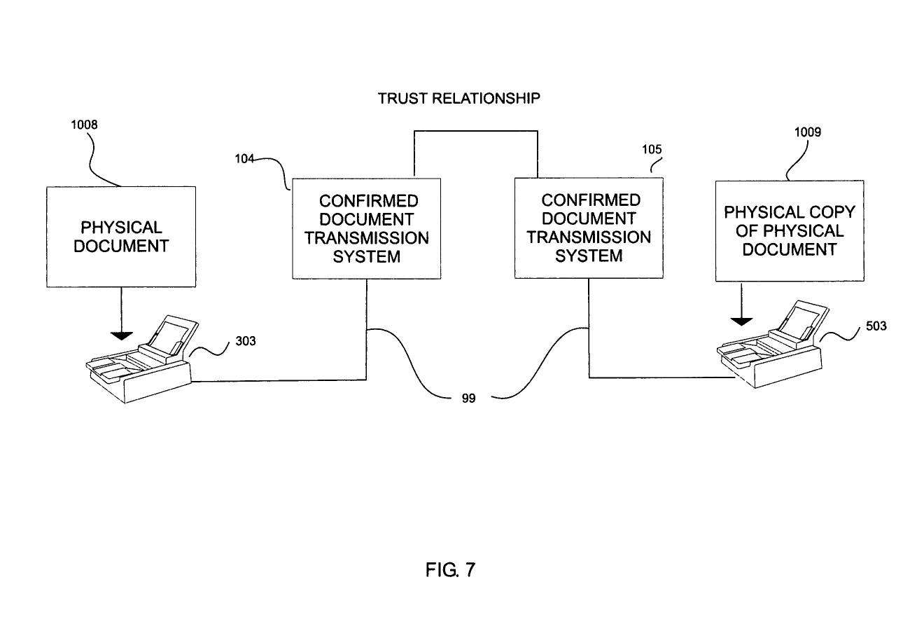

FIG. 7 is an exemplary overview of two confirmed document transmission systems 104-105 according to this invention. A sending user is authenticated to the fifth confirmed document transmission system 104 using a user identifier and password or the like, entered on the keyboard of the fourth multi-function device 303 or other means of authentication. The sending user scans the physical document 1008 using the scanning function of the fourth multi-function device 303. A receiving user is directly entered by the sending user and/or extracted from the document. The receiving user is a user of a sixth confirmed document transmission system 105. A trust relationship exists between the fifth and sixth confirmed document transmission systems 104-105. That is, the fifth confirmed document transmission system 104 trusts that the sixth confirmed document transmission system 105 will non-optionally confirm any access to the electronic document by an authenticated receiving user.

In various exemplary embodiments, the receiving user is optionally notified of the availability of the electronic document. The electronic document may be immediately transmitted to the sixth confirmed document transmission system 105, held pending authentication of the receiving user or the like. Once the receiving user is authenticated, the receiving user prints a physical copy using the print function of the fifth multi-function device 503. In response to the printing, reading or other access to the document, a non-optional delivery confirmation is recorded by the sixth confirmed document transmission system 105. The non-optional delivery confirmation may be an update to a non-optional delivery confirmation database or the like. The non-optional delivery confirmation provides the sender an indication that the document was successfully delivered to the intended recipient. In still other exemplary embodiments, a short message service (SMS) text message, facsimile, electronic mail message, chat or instant message or the like is used to notify the sender that a non-optional delivery confirmation has been recorded.

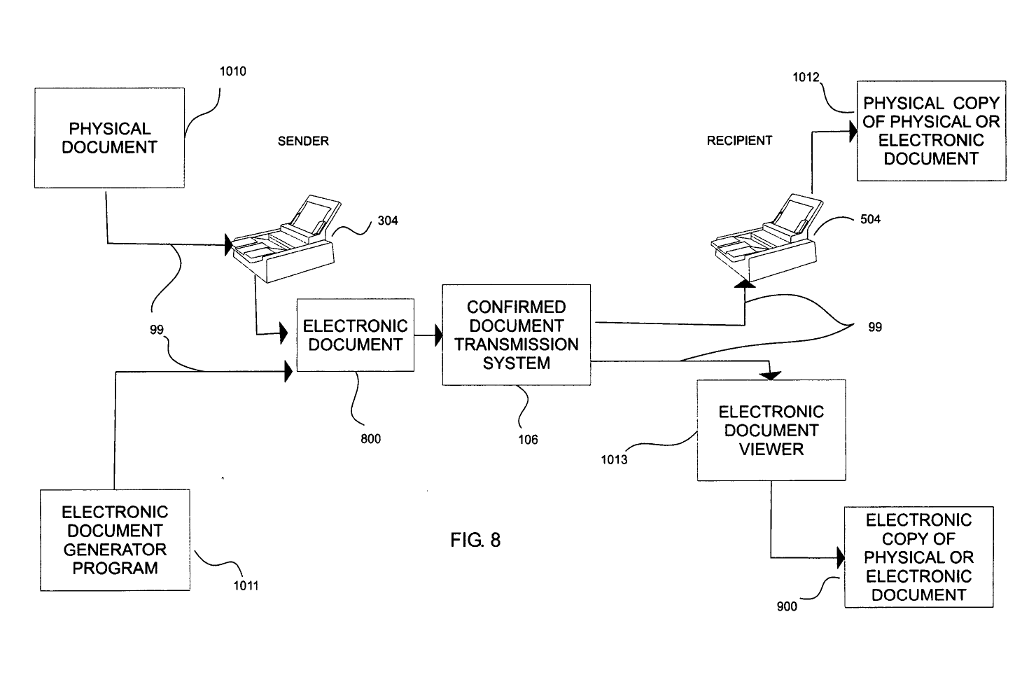

FIG. 8 is a third exemplary overview of a confirmed document transmission system 106 according to this invention. A sending user is authenticated to the seventh confirmed document transmission system 106. The sending user then creates electronic document 800. The electronic document is created by scanning the physical document 1010 using the sixth multi-function device 304 or accessed from a data source by the confirmed document transmission system 100. The data source may be a file system, a document repository or the like. In various embodiments, multiple data sources may be used without departing from the scope of this invention.

The seventh confirmed document transmission system 106 stores the electronic document and optionally notifies the receiving user of the availability of the document. The receiving user is authenticated to the seventh confirmed document transmission system 106 using a login sequence or the like. The receiving user optionally routes the electronic document to an appropriate output device. For example, a physical copy of the electronic document may be generated by printing the electronic document on the sixth multi-function output device 504. Alternately, the receiving user forwards the electronic document to an electronic document viewer 1013 to view the electronic document 900 directly. However, it should be apparent that the document may be forwarded to various other types of services without departing from the scope of this invention.

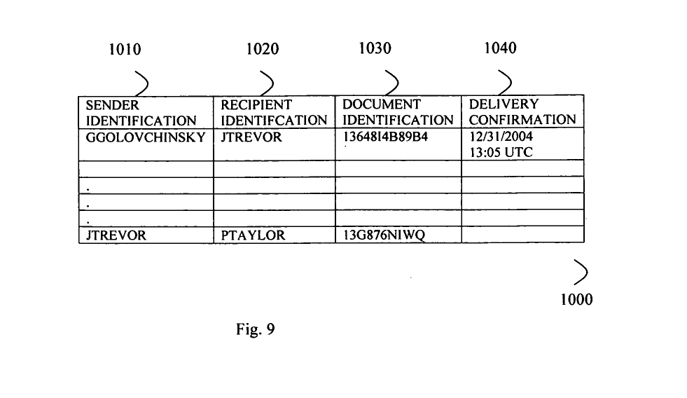

FIG. 9 is an exemplary data structure for storing delivery confirmation information 1000 according to this invention. The exemplary data structure for storing delivery confirmation information is comprised of a sender identification portion 1010, a recipient identification portion 1020, a document identification portion 1030, and a delivery confirmation portion 1040.

The first row of the exemplary data structure for storing delivery confirmation information 1000 contains the value “GGolovchinsky” in the sender identification portion 1010. The sender identification value may be a local identifier or a global identifier that uniquely identifies the originating user within the system for confirmed document transmission. For example, in some exemplary embodiments according to this invention, the sender is uniquely identified to the system using a globally unique email address or the like.

The recipient identification portion 1020 contains the value “JTrevor”. This value identifies the intended recipient of the document. The values in the recipient identification portion 1020 may include any locally or globally unique identifier that differentiates among the users of the system for confirmed document transmission.

The document identification portion 1030 contains the value “1364814B89B4”. This value uniquely identifies the document to be transferred to the recipient. The document identification value may be a uniform resource locator (URL) or any other known or later developed identifier useful in uniquely identifying the document within the system.

The delivery confirmation portion 1040 contains the value “Dec. 31, 2004 13:05 UTC”. This value indicates that the specified document was read or otherwise accessed by the intended recipient on Dec. 31, 2004 at 13:05 coordinated universal time. In various exemplary embodiments according to this invention, the delivery confirmation information is optionally transmitted to the sender via electronic mail, a voice mail message, a short message service, a chat message, a pager message, a text message and/or using any known or later developed notification method.

The last row of the exemplary data structure for storing delivery confirmation information 1000 contains the values “JTREVOR”, “PTAYLOR”, “13G876NIWQ” and“”. These values indicate that the document “13G876NIWQ” sent by user “JTREVOR” to receiving user “PTAYLOR” has not yet been accessed by the receiving user. Thus no time has been entered into the delivery confirmation portion 1040.

Each of the circuits 10-50 of the confirmed document transmission system 100 described in FIG. 4 can be implemented as portions of a suitably programmed general-purpose computer. Alternatively, circuits 10-50 of the confirmed document transmission system 100 outlined above can be implemented as physically distinct hardware circuits within an ASIC, or using a FPGA, a PDL, a PLA or a PAL, or using discrete logic elements or discrete circuit elements. The particular form each of the circuits 10-50 of the confirmed document transmission system 100 outlined above will take is a design choice and will be obvious and predicable to those skilled in the art.

Moreover, the confirmed document transmission system 100 and/or each of the various circuits discussed above can each be implemented as software routines, managers or objects executing on a programmed general purpose computer, a special purpose computer, a microprocessor or the like. In this case, the confirmed document transmission system 100 and/or each of the various circuits discussed above can each be implemented as one or more routines embedded in the communications network, as a resource residing on a server, or the like. The confirmed document transmission system 100 and the various circuits discussed above can also be implemented by physically incorporating the confirmed document transmission system 100 into software and/or a hardware system, such as the hardware and software systems of a web server or a client device.

As shown in FIG. 4, the memory store 20 can be implemented using any appropriate combination of alterable, volatile or non-volatile memory or non-alterable, or fixed memory. The alterable memory, whether volatile or non-volatile, can be implemented using any one or more of static or dynamic RAM, a floppy disk and disk drive, a write-able or rewrite-able optical disk and disk drive, a hard drive, flash memory or the like. Similarly, the non-alterable or fixed memory can be implemented using any one or more of ROM, PROM, EPROM, EEPROM, an optical ROM disk, such as a CD-ROM or DVD-ROM disk, and disk drive or the like. Moreover, in various exemplary embodiments according to this invention, the memory store 20 may be implemented as a document or information repository and/or any other system for storing and/or organizing documents. The memory store 20 may be embedded or accessed over communications links.

The communication links 99 shown in FIGS. 1 & 4 can each be any known or later developed device or system for connecting a communication device to the confirmed document transmission system 100, including a direct cable connection, a connection over a wide area network or a local area network, a connection over an intranet, a connection over the Internet, or a connection over any other distributed processing network or system. In general, the communication links 99 can be any known or later developed connection system or structure usable to connect devices and facilitate communication.

Further, it should be appreciated that the communication links 99 can be wired or wireless links to a network. The network can be a local area network, a wide area network, an intranet, the Internet, or any other distributed processing and storage network.

While this invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A confirmed document transmission apparatus comprising:
a user authentication manager that authenticates sending and receiving users;
a document digitizer for creating an electronic document for a sending user based on a first document;
a memory store for storing the electronic document;
a confirmation manager that records a non-optional delivery confirmation when an authenticated receiving user accesses the electronic document.

2. The apparatus of claim 1, in which the document digitizer is at least one of: a multi-function device, an audio digitizer, a video digitizer, and a text digitizer.

3. The apparatus of claim 2, in which the multi-function device is comprised of at least one of: a scanning portion and a printing portion.

4. The apparatus of claim 1, in which the memory store is a document repository.

5. The apparatus of claim 4, in which access to the information in the memory store is based on at least one of: a network protocol and a file system.

6. The apparatus of claim 1, in which access to the information in the memory store is based on direct memory access.

7. The apparatus of claim 5, in which the network protocol is at least one of: hyper text transfer protocol (HTTP), secure hypertext transfer protocol (HTTPS), file transfer protocol (FTP), secure file transfer protocol (SFTP), tiny file transfer protocol (TFTP), electronic mail (SMTP), and transfer control protocol (TCP).

8. The apparatus of claim 1, in which access is at least of: printing, facsimile transmission, reading, processing, parsing and downloading.

9. The apparatus of claim 1, in which the receiving user is a group comprising at least two members.

10. The apparatus of claim 9, in which the non-optional delivery confirmation is based on delivery to at least one of the members.

11. The apparatus of claim 10, in which the members are at least one of an individual, an organization and a team.

12. The apparatus of claim 1, in which the electronic document is output to at least one of: a printer; a multi-function device; and a facsimile device.

13. A method for confirmed document transmission comprising the steps of:
authenticating a sender;
determining an electronic document based on a first document;
storing the electronic document in a memory store;
determining an intended recipient of the electronic document;
non-optionally recording delivery of the electronic document when an authenticated recipient accesses the electronic document.

14. The method of claim 13, in which the first document is a physical document.

15. The method of claim 13, further comprising a notification manager that reports the availability of a received document to the receiving user.

16. The method of claim 13, in which the document to be transferred contains at least one of audio, video, textual and image information.

17. The method of claim 13, in which the non-optional delivery confirmation is based on a database entry.

18. The method of claim 13, in which the sender notification is based on the access to the electronic document by the receiving user.

19. The method of claim 13, in which the sender notification is reported to the sender via at least one of: electronic mail, short message service, voice mail, voice notification, pager notification, instant message, facsimile, audio notification and text messaging.

20. The method of claim 13, in which the receiver notification is reported to the recipient via at least one of: electronic mail, short message service, voice mail, voice notification, pager notification, instant message, facsimile, audio notification and text messaging.

21. A confirmed document transmission apparatus comprising:
a user authentication manager for authenticating sending and receiving users;
an input/output circuit for retrieving an electronic document specified by the sending user;
a memory for storing the electronic document;
a confirmation manager that provides a non-optional delivery confirmation that records when an authenticated receiving user accesses the electronic document.

22. The apparatus of claim 21, further comprising an output device for reproducing the accessed electronic document.

23. The apparatus of claim 21, further comprising an service for processing the accessed electronic document.

24. The apparatus of claim 22, in which the output device is at least one of: a multi-function device, a printer, a facsimile device and a display.

25. A computer readable storage medium comprising computer readable program code embodied on the computer readable storage medium, the computer readable program code useable to program a computer for confirmed document transmission comprising the steps of:
authenticating a sender;
determining an electronic document;
storing the electronic document in a document repository;
determining an intended recipient of the electronic document;
notifying the intended recipient of the availability of the electronic document;
non-optionally confirming delivery of the electronic document when an authenticated recipient accesses the electronic document.
